(19) United States
(12) Patent Application Publication
(10) Pub. No.: US 2003/0044037 A1
(43) Pub. Date: Mar. 6, 2003

(54) Free hearing-aid providing multi-shape and multi-function

(76) Inventor: Kwan-Sik Park, Jeollabuk-Do (KR)

Correspondence Address: LEVINE & MANDELBAUM, 350 FIFTH AVENUE SUITE 7814, EMPIRE STATE BUILDING, NEW YORK, NY, 10118, US

(21) Appl. No.: 09/995,089

(22) Filed: Nov. 27, 2001

(30) Foreign Application Priority Data
Sep. 3, 2001 (KR) 10-2001-54272

(51) Int. Cl. H04R 25/00

(52) U.S. Cl. 381/322; 381/328

(57) ABSTRACT

The present invention relates to hearing aid with various changes of shapes, more particularly to free hearing aid providing multi-shape and multi-function. The components of hearing aid—ear tip, shell, faceplate cover, faceplate, and battery room cover etc.—that are standardized suitably to various sizes of many people is produced on a large scale, and a coupling production that can combine and separate components of hearing aid easily changes the form of the hearing aid variously. Also, because only the replacement of battery room cover transforms the volume of a battery room, battery capacity of various sizes can be used.

### BACKGROUND

1. Field of Invention

The present invention relates to hearing aid with various changes of shapes, more particularly to free hearing aid providing multi-shape and multi-function. The components of hearing aid—ear tip, shell, faceplate cover, faceplate, and battery room cover etc.—that are standardized suitably to various sizes of many people is produced on a large scale, and a coupling production that can combine and separate components of hearing aid easily changes the form of the hearing aid variously. Also, because only the replacement of battery room cover transforms the volume of a battery room, battery capacity of various sizes can be used.

2. Description of Prior Art

Hearing handicapped people in order to hear more surely and comfortably uses hearing aid commonly. These and other features, and operations of the conventional hearing aid, accompanying drawings, is as follows.

FIGS. 4, 5, 6 are a fragmentary perspective, a coherent perspective and a plane of the prior art. The structure of conventional hearing aid (900), as described in FIGS. 4, 5, 6, comprises shell (700), which is copied from the pattern of ear based on an auricle and external ear of the user and is made by handiwork; faceplate (800) combined with shell (700) by adhesives, which is connected and equipped on a microphone (460), an amplifier (420), a receiver (360), a battery room (870), and a sound controller (440); a microphone (460) equipped on faceplate (800), converting sound signal into electronic signal and connecting amplifier (420) by connecting lines; an amplifier (420) equipped on faceplate (800) as a shape of a chip, amplifying electronic signal enough that comes from microphone (460); a receiver(360), linking by the connecting lines of the amplifier equipped on faceplate (800) and converting amplified electronic signal into sound signal; a sound guide tube (310), transmitting sound signal converted from receiver(360) and offering an output to the upper end outlet of the shell(700); a fixed cover of the receiver(320), fixing receiver(360) to the sound guide tube (310); a sound controller (440), linking by the amplifier (420) equipped on faceplate (800) and controlling volume of a sound by user of the hearing aid; a battery room (870) equipped on faceplate (800), possessing a battery supplied the source of electronic power to a microphone (460), an amplifier (420), a receiver (360); a door of battery room (850) fixed on the lower end of faceplate (800).

But, a type of the shell (700), which is copied from the pattern of ear based on an auricle and external ear of the user and made by hand, varies with the pattern of the ear of user. For that reason, because the standardization of the shell that is fitted to the pattern of ear by various sizes of many people is impossible, production on a large scale of hearing aid is very difficult.

Besides, the cohesion of the shell (700) and the faceplate (800) is adhered to outer section of the lower end of the shell (700) and top surface of the faceplate (800).

Accordingly, when mending and replacing work is occurred by the defect of hearing aid component equipped on faceplate (800), the shell (700) and faceplate (800) equipped on hearing aid component must separate. As a adhesive portion of outer section of the lower end of the shell (700) and top surface of the face plate (800) must separate compulsorily, damage of component equipped on surface of the shell (700) and the face plate (800) and a cut of separation worker by use of tool (knife, etc.) for compulsory separation occur on this process.

And, but a volume of the hearing aid differ according to sizes of an auricle and external ear of the user, this difference is so small that a small size and capacity of battery is more adjustable than a huge size and capacity.

But, in order to use hearing aid for many hours, a huge capacity of battery is needed. Though the conventional hearing aid (900) uses a small capacity of battery that must increase a volume of battery (870) in order to use a huge capacity of battery, a conventional volume of battery (870) is restricted by a regular capacity of battery size. Therefore, without alteration of an external structure of hearing aid, increase of a volume of battery (870) is impossible.

And, most of user's ear secretes earwax. Earwax make clean the inside structure of ear, on the other side, earwax flows in a receiver through sound guide tube of hearing aid. If earwax flows in a receiver, a fit operation of the receiver is blocked up and a disorder of the receiver is caused.

### SUMMARY OF THE INVENTION

In order to overcome the conventional problems, an object of the present invention is to produce ear tip, shell, faceplate cover, faceplate, and battery room cover etc. on a large scale according to a pattern of ear that is standardized fitly to various sizes of many people, and cut down manufacturing cost of hearing aid by production on a large scale.

Another object of this invention is to provide improved mending and replacing process without damage of hearing aid components by easy combination and separation of hearing aid components when disorder of components is occurred.

A further object of this invention is to embody an epoch-making process of hearing aid that produces each component independently, which is altered function of some component without structure alteration of another components and is to provide a diversified function of hearing aid by cohesion structure.

A still further object of this invention is to provide a huge size and capacity of battery that uses for many hours. Without the structure alteration of the hearing aid, only transformation of battery room cover that can be transformed a volume of the battery room, which is inserted a battery, is able to use a small size and capacity of a battery for many hours.

An additional object of this invention is to prevent disorder of hearing aid from earwax that interrupts a fit operation and output of power of the receiver. Earwax flowing in the receiver through sound guide tube is cut off by a minute netting cover of outer portion of the receiver.

### BRIEF DESCRIPTION OF DRAWINGS

Further objects and advantages of the present invention will be apparent from the following description, reference being had to the accompanying drawings wherein preferred embodiment of the present invention are clearly shown.

In the drawings:

FIG. 1 is a fragmentary perspective of the hearing aid according to the present invention.

FIG. 2 is a coherent perspective of the hearing aid according to the present invention.

FIG. 3 is a plane of the hearing aid according to the present invention.

FIG. 4 is a fragmentary perspective of the conventional hearing aid.

FIG. 5 is a coherent perspective of the conventional hearing aid.

FIG. 6 is a plane of the conventional hearing aid.

FIG. 7 is a plane of combination and separation of the ear tip and the shell of the hearing aid according to the present invention.

FIG. 8 is a plane of combination and separation of the shell and the faceplate cover of the hearing aid according to the present invention.

FIG. 9 is a plane of combination and separation of the faceplate cover and the faceplate of the hearing aid according to the present invention.

FIG. 10 is a plane of combination and separation of the faceplate and the battery room cover of the hearing aid according to the present invention.

FIG. 11 is a perspective of the battery room cover of the hearing aid according to the present invention.

FIG. 12 is a plane of the battery room cover of the hearing aid according to the present invention.

FIG. 13 is a perspective of the battery room door of the conventional hearing aid.

FIG. 14 is a plane of the battery room door of the conventional hearing aid.

FIG. 15 is a plane of the shell and ear tip of the hearing aid according to the present invention.

FIG. 16 is a plane of the locking sill of the sound guide tube according to the present invention.

FIG. 17 is a perspective of a net filter in order to protect the receiver according to the present invention.

FIG. 18 is a making process of the shell of the conventional hearing aid.

### DETAILED DESCRIPTION OF PREFERRED EMBODIMENT

Hereinafter, preferred embodiment of the present invention will be described in detail with reference to the accompanying drawings.

A structure of the hearing aid according to present invention comprises an ear tip (100) standardized fitly to various sizes of many hearing aid users; a shell (200) standardized fitly to various sizes of the pattern of the ear of many hearing aid users, and connected by the structure of combination and separation of the ear tip (100) and a cohesion groove (220), a cohesion sill (120); a faceplate cover (300) connected by the structure of combination and separation of the shell (200) and a cohesion groove (240), a cohesion sill (310); a faceplate (400) equipped on an amplifier (420), a receiver (360), a battery room (560), and a sound controller (440) and connected by the structure of combination and separation of the faceplate cover (300) and a cohesion groove (350), a cohesion sill (470); a microphone (460) equipped on the faceplate (400) and connected by the amplifier (420) as a role of converting sound signal into electronic signal; an amplifier (420) equipped on faceplate (400) as a shape of a chip, amplifying electronic signal enough that comes from the microphone(460); a receiver(360) equipped on the faceplate (400) and connected by the amplifier (420) as a role of converting electronic signal into sound signal; a sound guide tube (260), transmitting sound signal converted and output from a receiver(360) to upper end outlet of the shell(200); a sound controller (440), linking to the amplifier (420) equipped on faceplate (400) and controlling volume of a sound by user of the hearing aid; a battery room (560) equipped on faceplate (400), possessing a battery that supplies the source of electronic power to a microphone (460), an amplifier (420), a receiver (360); a cover of battery room (500) connected by the structure of combination and separation of a cohesion groove (480,495) formed on the lower end of faceplate (400) and a cohesion sill (520,540) formed on the upper end of the cover of battery room (500).

The invention will now be described with reference to the accompanying drawings wherein.

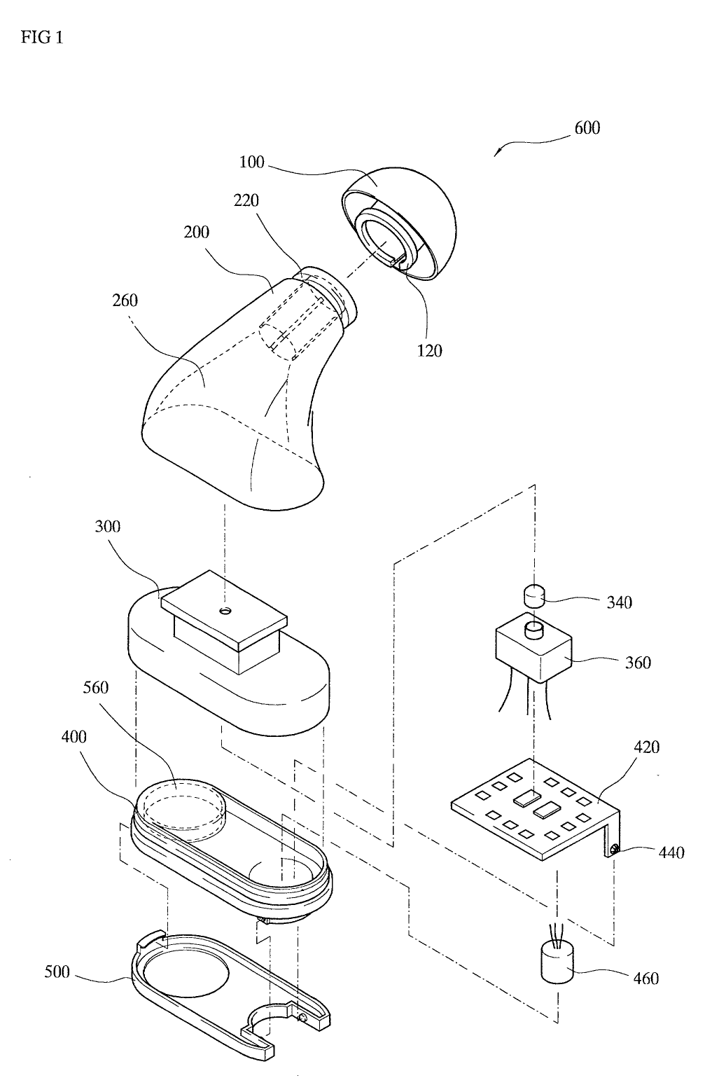

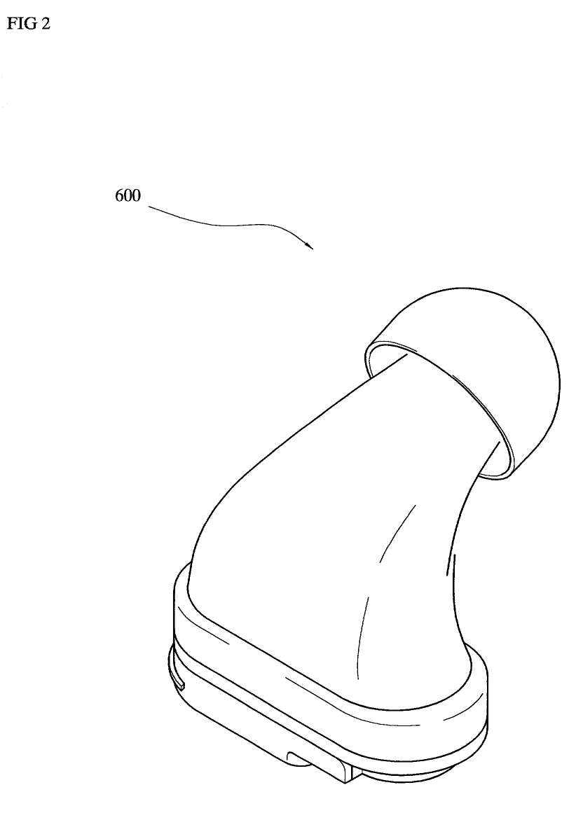

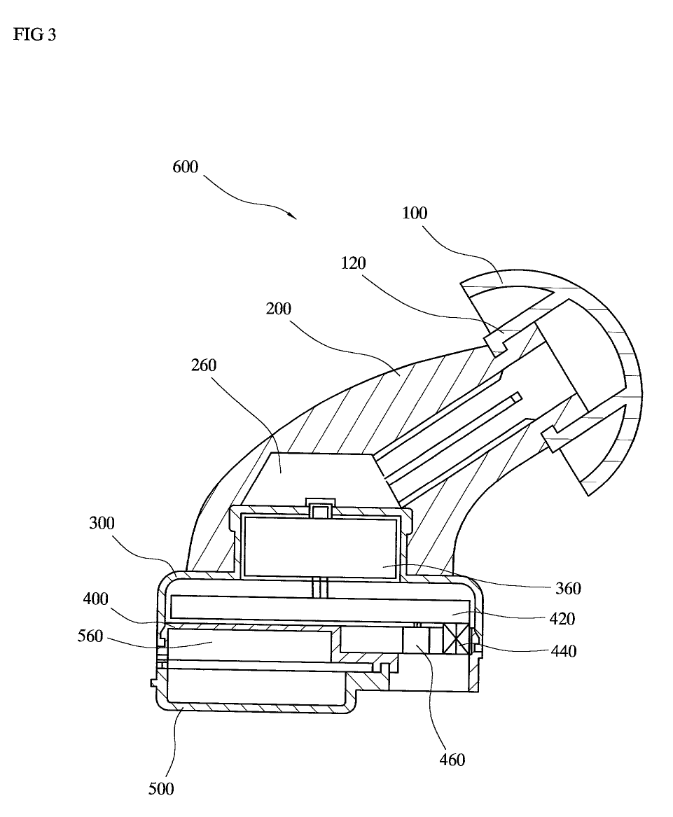

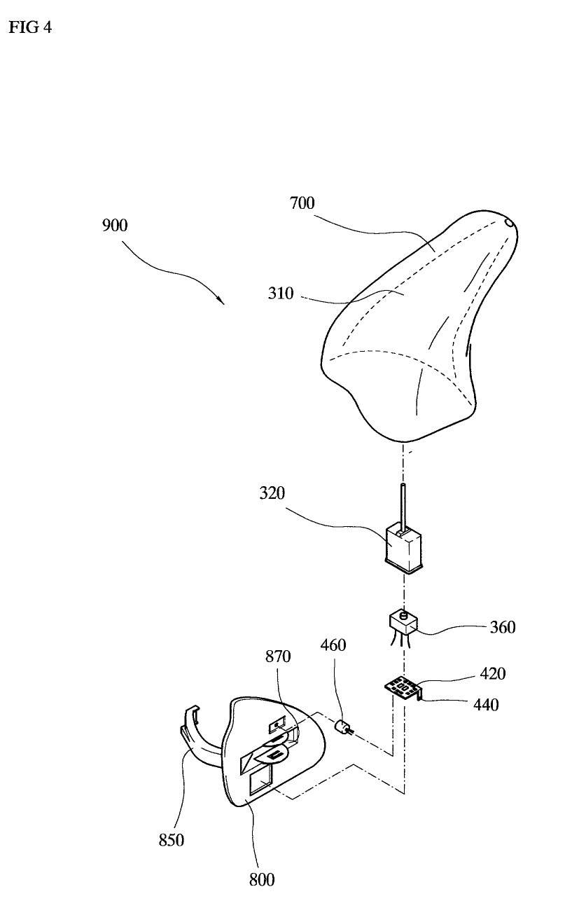

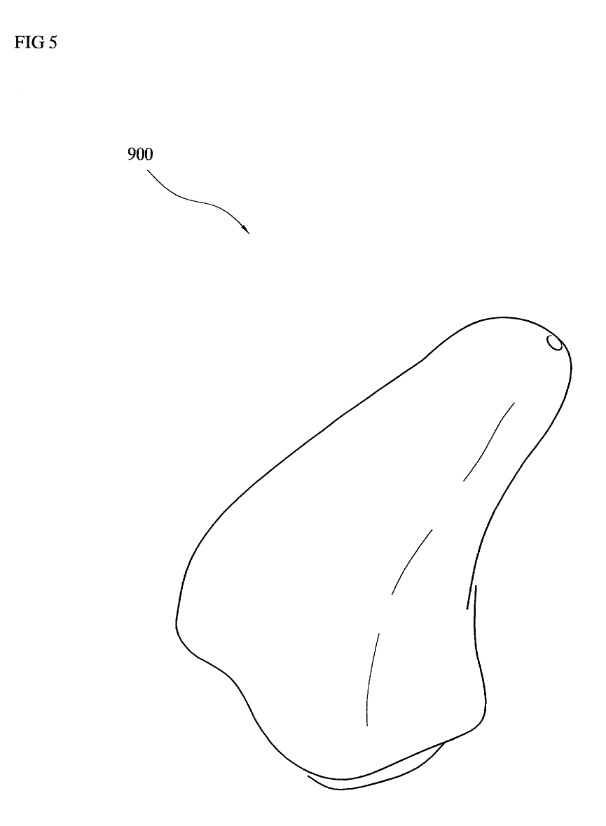

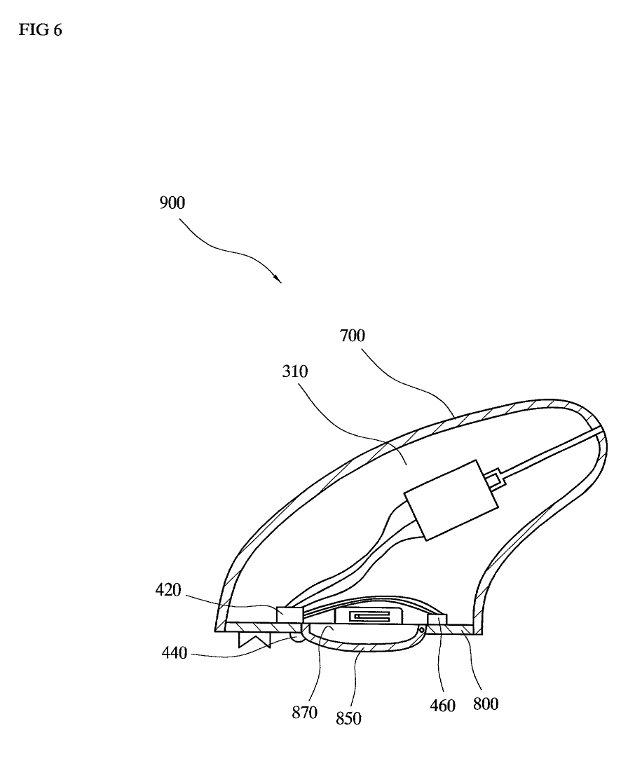

FIGS. 1, 2, 3 are a fragmentary perspective, a coherent perspective and a plane of the free hearing aid providing multi-shape and multi-function according to the present invention.

The ear tip (100), as described in FIGS. 1, 2, 3, is standardized fitly to various sizes of many hearing aid users.

Especially, the ear tip (100) and the shell (200) are made by structure of combination and separation. Because the shell is standardized fitly to various sizes by a cohesion groove (220) and a cohesion sill (120), many hearing aid users are able to use hearing aid fitly.

Besides, as the quality of the material of the ear tip use silicon that provided smooth and comfortable wearing, a sanitary problem is not occurred by contacting of the surface of the external ear and a transformation of the silicon by constriction and swelling is possible according to size of the inside diameter of external ear.

Because the shell (200) is made by the ear tip (100), a cohesion groove (220) and a cohesion sill (120) with the structure of the combination and separation that are standardized fitly to various sizes in the upper end of the shell (200) and faceplate cover (300), a cohesion groove (240) and a cohesion sill (310) in the lower end of the shell (200), a pattern of the ear standardized suitably to various sizes of many hearing aid users are able to use hearing aid fitly.

Inside of the shell (200) is equipped on sound guide tube (260) that installed 4 locking sills respectably to inner portion in the direction of an angle of 90 degrees. Therefore, when a sound signal is moving to the outlet of the outer cover, a pressure of sound is improved by changing of inside density because of 4 locking sills.

As the quality of the material of the shell (200) use silicon that provided smooth and comfortable wearing, a sanitary problem is not occurred by contacting of the surface of the external ear and a transformation of the silicon by constriction and swelling is possible according to size of the inside diameter of external ear.

The faceplate cover (300) is made by the structure of the combination and separation with the shell (200), a cohesion groove (240) and a cohesion sill (310) in the upper end and the faceplate (400), a cohesion groove (350) and a cohesion sill (470) in the lower end.

The faceplate (400) equipped on an amplifier (420), a receiver (360), a battery room (560), and a sound controller (440) is made by the structure of the combination and separation with the faceplate cover (300), a cohesion groove (350) and a cohesion sill (470) in the upper end of the faceplate (400) and the battery room cover (500), a cohesion groove (480) and a cohesion sill (540) in the lower end of the faceplate (400).

The microphone (460) equipped on the faceplate (400) is connected by 3 lines to the amplifier (420) as a role of converting sound signal into electronic signal.

The amplifier (420) is equipped on faceplate (400) as a shape of a chip, amplifying electronic signal enough that comes from the microphone (460).

The receiver (360) equipped on the faceplate (400) is connected by 3 lines to the amplifier (420) as a role of converting electronic signal into sound signal, and the netting filter (340) is equipped. The netting filter protects the receiver (360) against access of an alien substance.

The sound guide tube (260) is transmitting sound signal converted and output from receiver (360) to upper end outlet of the shell (200), and is installed 4 locking sills respectably to inner portion in the direction of an angle of 90 degrees. Therefore, as a pressure of sound is improved by changing of inside density of sound guide tube (260), a maintaining of a direction of a sound wave prevents a transformation of a sound wave.

The sound controller (440) linked to the amplifier (420) equipped on faceplate (400) can be controlled volume of a sound by user of the hearing aid.

The battery room (560) equipped on faceplate (400) possesses a battery being supplied the source of electronic power to a microphone (460), an amplifier (420), a receiver (360) and a sound controller (440).

The sound signal being moved to an external ear of the outside of hearing aid through the sound guide tube (260) and the outlet (150) of the outer cover of hearing aid and being passed an external ear, vibrates the eardrum of the hearing aid user.

The battery room cover is connected by the structure of the combination and separation with a cohesion groove (480, 495) formed to the lower end of the faceplate (300) and a cohesion sill (520, 540) formed to the upper end of the battery room cover (500).

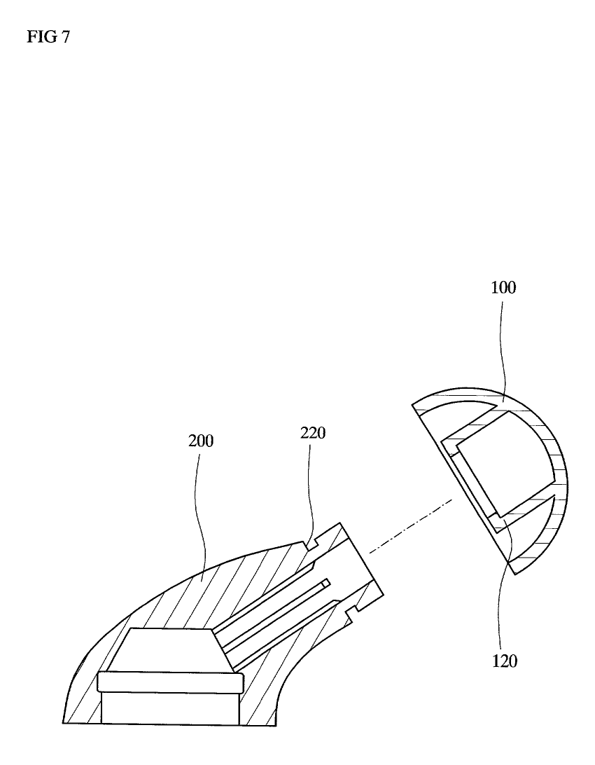

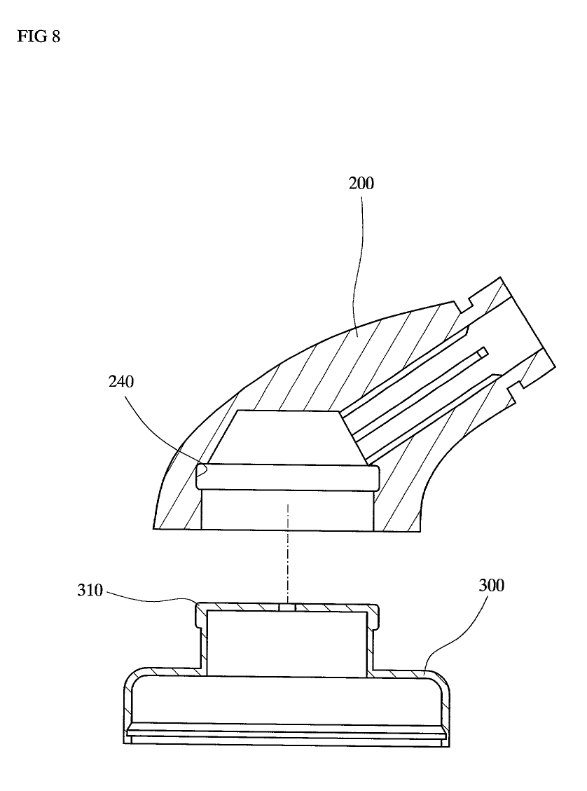

FIG. 7 is a plane of combination and separation of the ear tip (100) and the shell (200) of the hearing aid according to the present invention.

The ear tip (100) and the shell (200) standardized fitly to various sizes of many hearing aid users, is made by structure of combination and separation with a cohesion sill (120) formed to the lower end of the ear tip (100) and a cohesion groove (220) formed to the upper end of the shell (200).

Especially, as the quality of the material of the ear tip (100) and the shell (200) use silicon transformed by constriction and swelling according to size of the inside diameter of external ear in order to be combined and separated by a minute pressure.

FIG. 8 is a plane of combination and separation of the shell and the faceplate cover of the hearing aid according to the present invention.

The shell (200) that is standardized by fit, various sizes of the pattern of the ear, is made by the structure of the combination and separation with a cohesion groove (240) formed to surface of inside of the shell (200) and a cohesion sill (310) formed to the upper end of the faceplate cover (300).

Especially, as the quality of the material of the shell (200) use silicon transformed by constriction and swelling according to size of the external form of earlobe and the inside diameter of external ear in order to be combined and separated by a minute pressure.

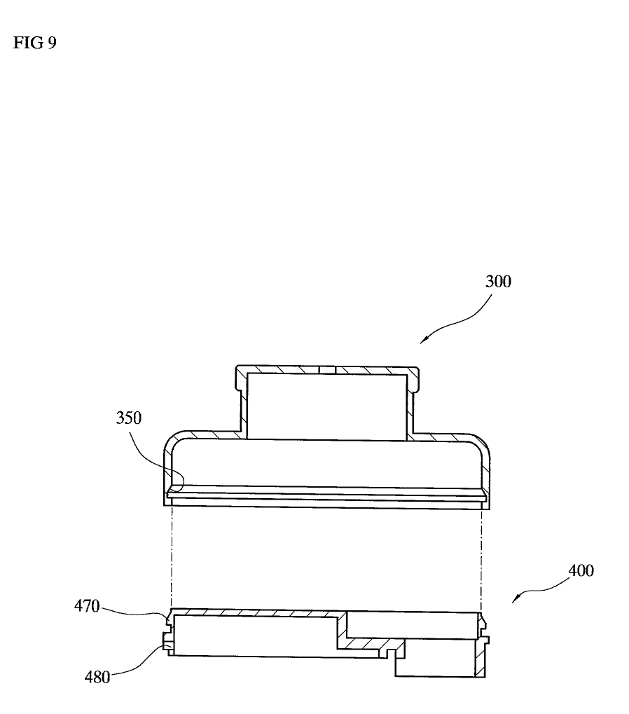

FIG. 9 is a plane of combination and separation of the faceplate cover and the faceplate of the hearing aid according to the present invention.

The faceplate (400) equipped on an amplifier (420), a receiver (360), a battery room (560), and a sound controller (440) is made by the structure of the combination and separation with a cohesion groove (350) formed to the lower end of the faceplate cover (300) and a cohesion sill (470) formed to the upper end of the faceplate (400).

Especially, one-touch button formed to the lower end of a cohesion sill (470) of the faceplate (400) for combination and separation is produced to separate by pressing or compulsory insert.

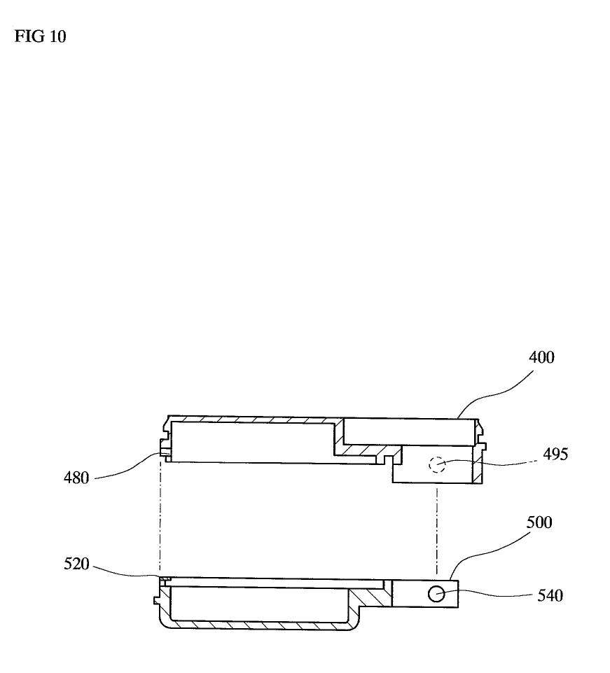

FIG. 10 is a plane of combination and separation of the faceplate and the battery room cover of the hearing aid according to the present invention.

A cohesion groove (490, 495) formed to the lower end of the faceplate (400) and a cohesion sill (520, 540) formed to the upper end of the faceplate cover (500), is combined and separated by a minute pressure.

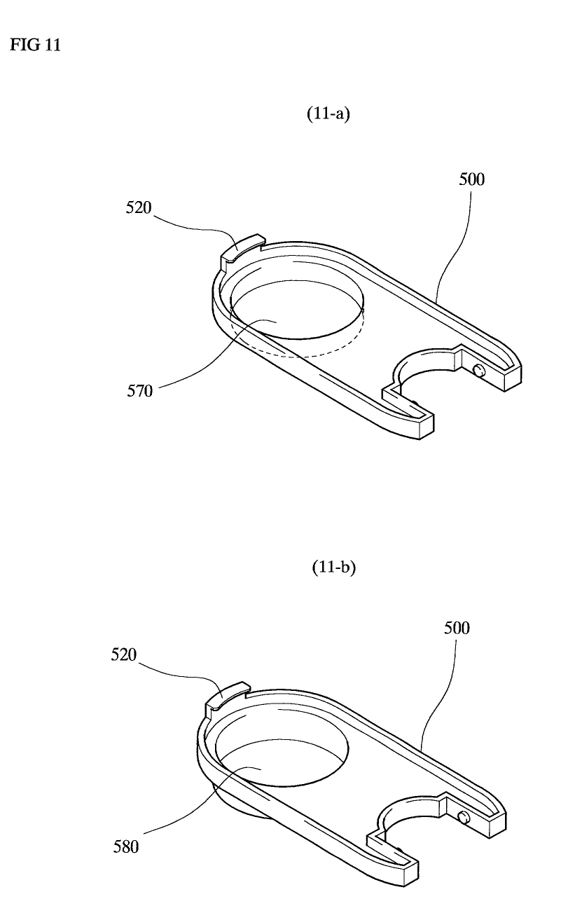

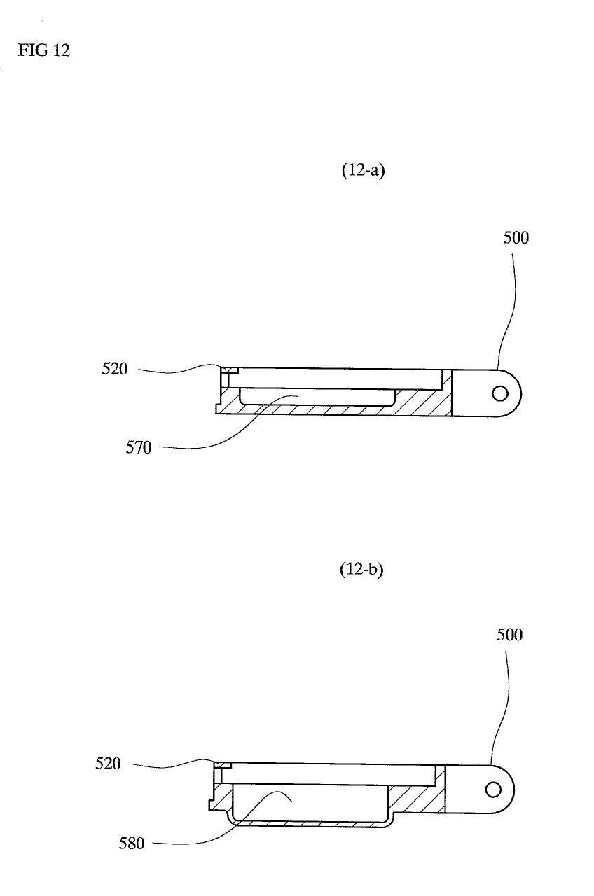

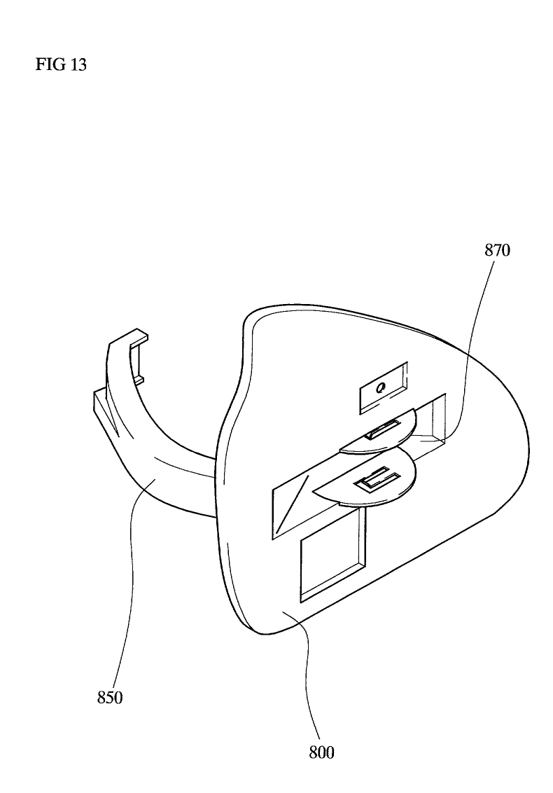

FIGS. 11, 12 are a perspective and a plane of the battery room cover of the hearing aid according to the present invention.

The source of electronic power of the hearing aid is a 1.4-volt. A bottom area, height of a battery and a volume of a battery room are different according to a capacity of a battery.

The battery room cover (500) is combined and separated by a cohesion sill (520). only transformation and replacement of battery room cover that can be transformed a volume of the battery room which is inserted a battery, alter small size and capacity of battery room (570) into huge size and capacity of battery room (580).

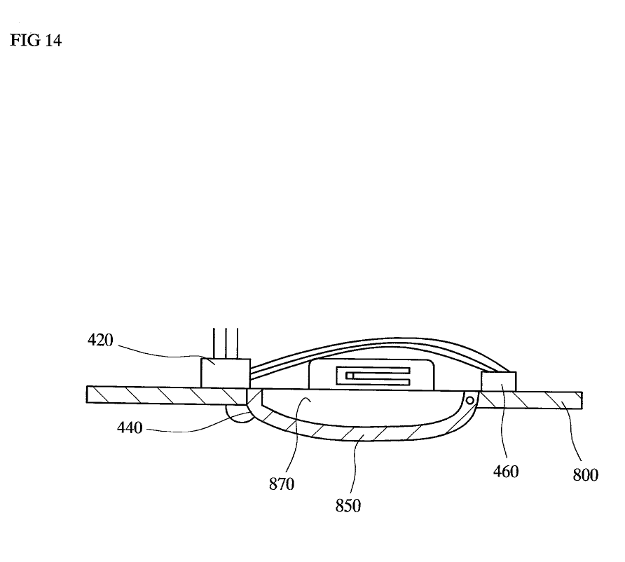

FIGS. 13, 14 are a perspective and a plane of the battery room door of the conventional hearing aid.

The conventional hearing aid (900) that is made fitly to a volume of battery room (870) of fixed battery size and capacity can be inserted and fixed a battery by a battery room door (850).

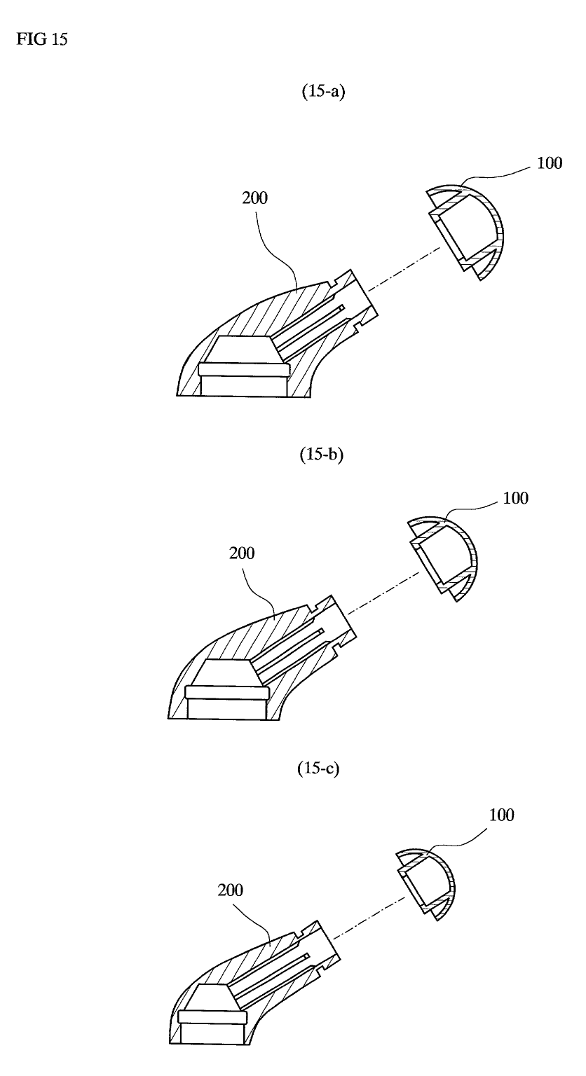

FIG. 15 is a plane of the shell and ear tip of various size of the hearing aid according to the present invention.

The ear tip (100) and the shell (200) are standardized fitly to various sizes (15-a, 15-b, 15-c) of many hearing aid users.

Accordingly, the ear tip (100) reduced and altered uniformly by a size of the inside diameter of external ear is made in various and standardized sizes. Because the shell (200) use a reduced and altered silicon uniformly that can be transformed by constriction and swelling according to a structure of external form of an auricle and a size of the inside diameter of external ear, the shell (200) is made in various and standardized sizes.

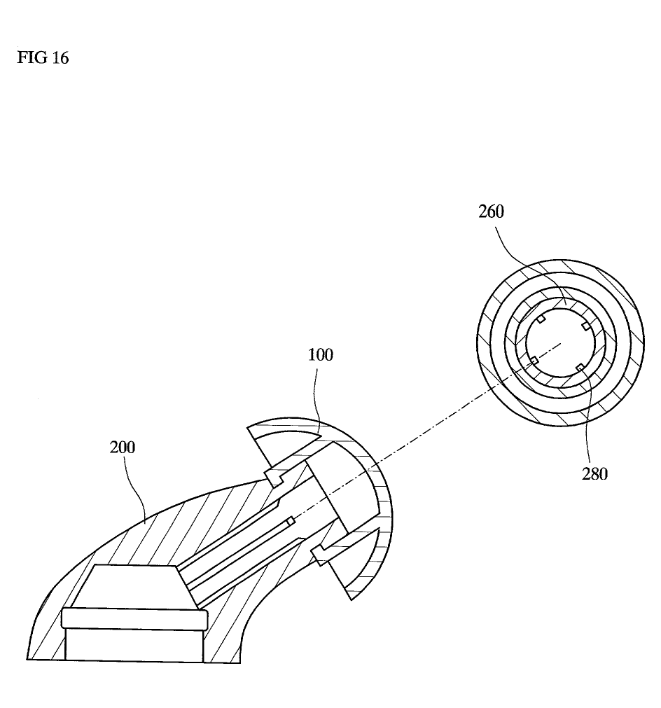

FIG. 16 is a plane of the locking sill of the sound guide tube according to the present invention.

The sound guide tube (260) is transmitting sound signal converted and output from receiver (360) to upper end outlet of the shell (200), and is installed 4 locking sills respectably to inner portion in the direction of an angle of 90 degrees. Therefore, as a pressure of sound is improved by changing of inside density of sound guide tube (260), a maintaining of a direction of a sound wave prevents a transformation of a sound wave.

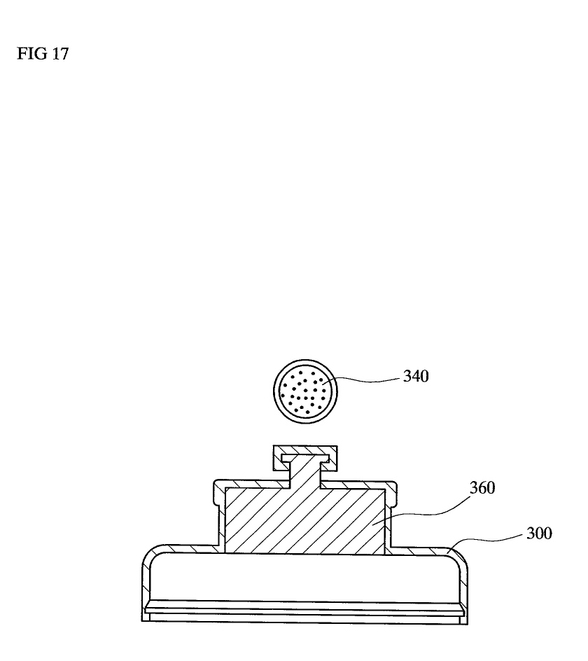

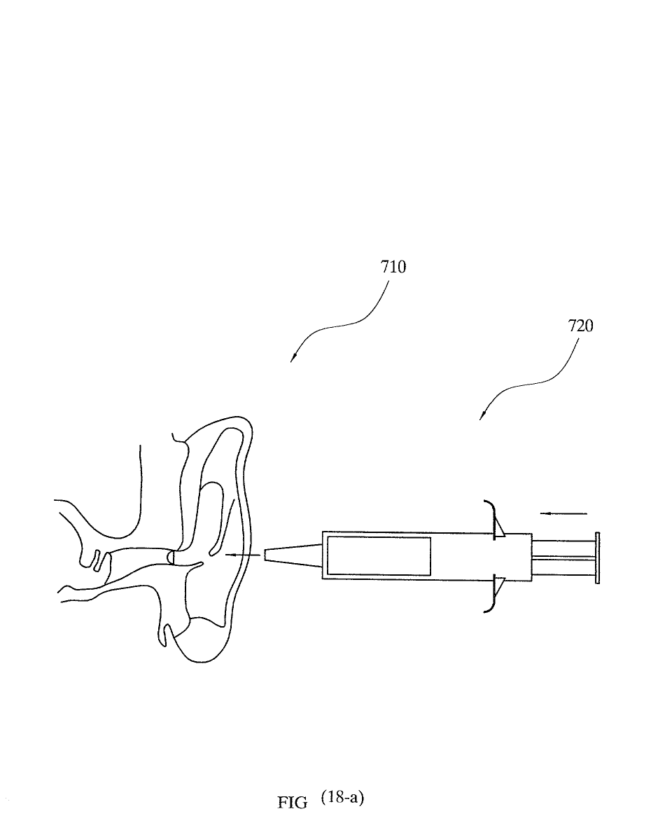

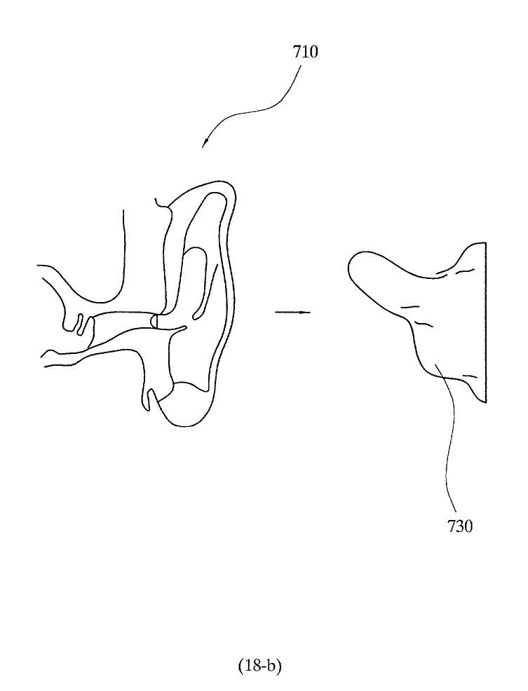

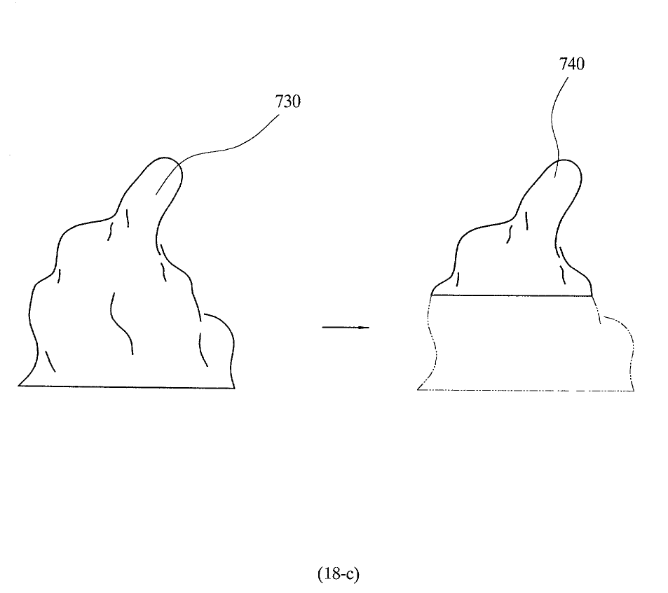

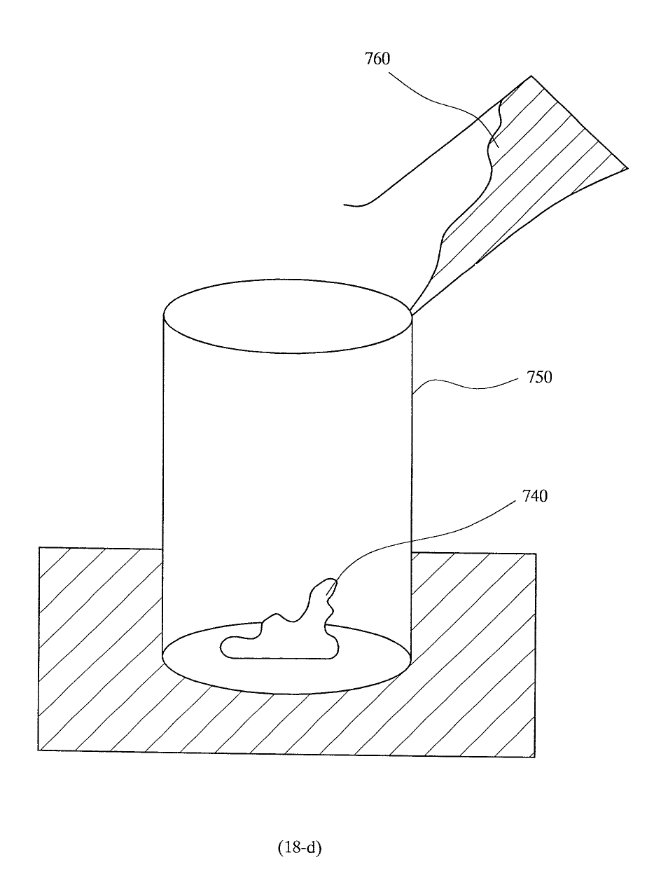

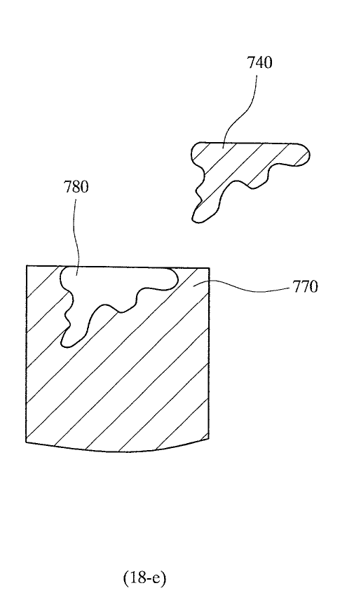

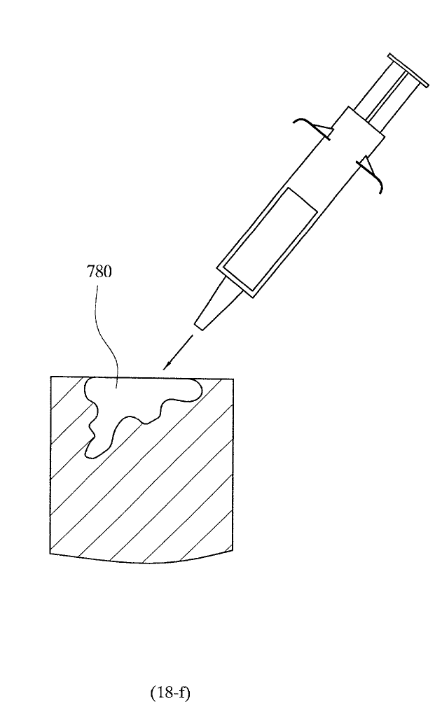

FIG. 17 is a perspective of a net filter in order to protect the receiver according to the present invention.

The net filter (340) installed minutely to the outer portion of the receiver (360) prevents earwax that is flowing in receiver through the sound guide tube (260) and protects the receiver (360).

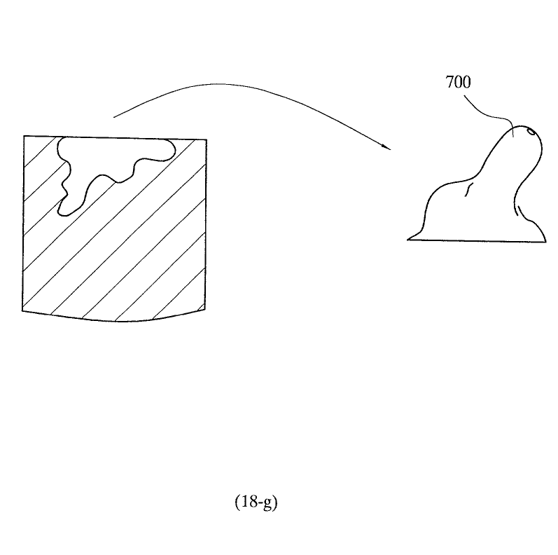

FIG. 18 is a making process of the shell of the conventional hearing aid.

The making process of the shell is as follows:

The spout process (18-a) is to spout and insert to the surface of the ear (710) of hearing aid user through injector (730) inserted the silicon.

The separation process (18-b) separates ear mold (730) that is copied from a shape of ear, and that become hard in the condition of gel on the surface of the ear (710).

The cutting process (18-c) cuts the separated ear mold (730) fitly to a shape of ear.

The mixing process (18-d) lays the cut ear mold (740) on the center portion working board, and puts a beaker (750) of a column shape of both sides open on the ear mold, and pours AGAR on sol conditions of chemistry solution into the inner portion of a column.

The mold creation process (18-e) is created mold in the upper end portion of AGAR. After the ear mold (740) and the column poured AGAR of an invariable ratio let cool completely in water, turning out the working board, and removing the working board and the column, the mold and AGAR that become hard on the mold leave into the column shape being turned upside down in an angle of 180 degrees. At this time, the ear mold (740) is placed on the upper end portion of the column. As the ear mold (740) placed on the upper end portion separates from AGAR that become hard, a separated mold shape is created in the upper end portion of AGAR.

The process of pouring in (18-f) is to pour a resin of mixing solution into the mold of AGAR.

The final process (18-g) is to put final touches and cutting on a hardened resin that is separated from AGAR after hardening of a limited time.

Consequently, the present invention has some advantages as follows.

A pattern of ear of hearing aid user is different according to each and every person. If the making process of the shell by handiwork is improved, production on a large scale of the shell can be possible by standardizing with various sizes of a pattern of ear. Therefore, as a process of handiwork decreases in making process, manufacturing cost of hearing aid cut down by shortening of manufacturing term.

Besides, this invention is to provide improved mending and replacing process without damage of hearing aid components by making easily combination and separation of hearing aid components when disorder of components is occurred. Only alteration of some component can be altered a function of hearing aid variously.

Moreover, only transformation of battery room cover, because a small size and capacity of a battery transforms into a huge size and capacity of a battery, an equal battery can use for many hours without replacement of a battery. Also, as a price of a battery of huge capacity is equal with small battery, use of a battery of huge capacity can cut down a cost sharply.

Besides, an effect of this invention is to prevent disorder of hearing aid from earwax that interrupts a fit operation and an output of power of the receiver. Earwax flowing in the receiver through sound guide tube is cut off by a minute netting cover of outer portion of the receiver. That is, the expected life span of hearing aid make longer.

Moreover, as the locking sills (280) formed in inside of the sound guide tube (260) improves a pressure of sound by changing of inside density of the sound guide tube (260), a maintaining of a direction of a sound wave prevents a transformation of a sound wave.

This invention is explained by the preferred embodiments, and those who have a common knowledge in technical field of this invention will transform and apply variously within the scope of this invention illustrated, described, and claimed herein.

This invention may be practiced or embodied in still other ways without departing from the notion or essential character. The preferred embodiments described herein are therefore illustrative and not restrictive, the scope of this invention being indicated by the appended claims and all variations which come within the meaning of the claims are intended to be embraced therein.

What is claimed is:

1. Free hearing aid providing multi-shape and multi-function comprising:
an ear tip (100) standardized fitly to various sizes of many hearing aid users; and
a shell (200) standardized fitly to various sizes of the pattern of the ear of many hearing aid users, and connected by the structure of combination and separation of the ear tip (100) and a cohesion groove (220), a cohesion sill (120); and
a faceplate cover (300) connected by the structure of combination and separation of the shell (200) and a cohesion groove (240), a cohesion sill (310); and
a faceplate (400) equipped on an amplifier (420), a receiver (360), a battery room (560), and a sound controller (440) and connected by the structure of combination and separation of the faceplate cover (300) and a cohesion groove (350), a cohesion sill (470); and
a microphone (460) equipped on the faceplate (400) and connected by the amplifier (420) as a role of converting sound signal into electronic signal; and
an amplifier (420) equipped on faceplate (400) as a shape of a chip, amplifying electronic signal enough that comes from the microphone(460); and
a receiver(360) equipped on the faceplate (400) and connected by the amplifier (420) as a role of converting electronic signal into sound signal; and
a sound guide tube (260),transmitting sound signal converted and output from receiver(360) to upper end outlet of the shell(200); and
a sound controller (440), linking to the amplifier (420) equipped on faceplate (400) and controlling volume of a sound by user of the hearing aid; and
a battery room (560) equipped on faceplate (400), possessing battery that supplies the source of electronic power to a microphone (460), an amplifier (420), a receiver (360); and
a cover of battery room (500) connected by the structure of combination and separation of a cohesion groove (480,495) formed on the lower end of faceplate (400) and a cohesion sill (520,540) formed on the upper end of the cover of battery room (500).

2. Free hearing aid providing multi-shape and multi-function as claimed in the claim 1,
whrerin only transformation and replacement of battery room cover (500) that can be transformed a volume of the battery room (560), which is inserted a battery, a small size and capacity of a battery room (570) alters a huge size and capacity of a battery (580).

3. Free hearing aid providing multi-shape and multi-function as claimed in the claim 1,
wherein the net filter (340) installed minutely to the outer portion of the receiver (360) prevents earwax that is flowing in receiver through the sound guide tube (260).

4. Free hearing aid providing multi-shape and multi-function as claimed in the claim 1,
wherein the inside portion of the sound guide tube (260) is installed 4 locking sills respectably in the direction of an angle of 90 degrees. Therefore, as a pressure of sound is improved by changing of inside density of sound guide tube (260), a maintaining of a direction of a sound wave prevents a transformation of a sound wave.
